(19) United States
(12) Patent Application Publication
(10) Pub. No.: US 2026/0002312 A1
(43) Pub. Date: Jan. 1, 2026

(54) LAUNDRY APPLIANCE DOOR ASSEMBLIES AND METHODS OF MANUFACTURING SUCH ASSEMBLIES

(71) Applicant: Haier US Appliance Solutions, Inc., Wilmington, DE (US)

(72) Inventors: Venkata Chakradhar Rangu, Louisville, KY (US); Jordan Kyle Weidner, Louisville, KY (US); Christopher Gene Vowels, Cox’s Creek, KY (US)

(21) Appl. No.: 18/760,975

(22) Filed: Jul. 1, 2024

(51) Int. Cl. D06F 39/14; B29C 65/00; B29C 65/20; B29C 65/60; B29L 31/00; D06F 23/02; D06F 58/02; D06F 58/20

(52) U.S. Cl. CPC D06F 39/14; B29C 65/20; B29C 65/606; B29C 66/81423; D06F 23/02; D06F 58/02; D06F 58/20; B29L 2031/762

(57) ABSTRACT

A door assembly for a laundry appliance includes an inner frame, a window in the inner frame, an outer frame outboard of the inner frame and the window and a grille mounted to the outer frame. A method of assembling the door assembly may include forming a cap on one of the grille or the outer frame by heat stake welding. The grille is coupled to the outer frame by the heat stake welded cap as a result of forming the cap by heat stake welding.

### FIELD OF THE INVENTION

The present subject matter relates generally to laundry appliances, such as washing machine appliances and dryer appliances, and in particular to door assemblies for such appliances.

### BACKGROUND OF THE INVENTION

Laundry appliances, such as washing machine appliances and dryer appliances, generally include a rotatable vessel therein. For example, washing machine appliances generally include a tub for containing water or wash fluid, e.g., water and detergent, bleach, and/or other wash additives. A basket is rotatably mounted within the tub and defines a wash chamber for receipt of articles for washing. During normal operation of such washing machine appliances, the wash fluid is directed into the tub and onto articles within the wash chamber of the basket. The basket can rotate at various speeds to agitate articles within the wash chamber, to wring wash fluid from articles within the wash chamber, etc. As another example, the rotatable vessel may be a drum of a clothes dryer appliance. A conventional appliance for drying articles such as a clothes dryer (or laundry dryer) for drying clothing articles typically includes a cabinet having a rotating drum for tumbling clothes and laundry articles therein. One or more heating elements heat air prior to the air entering the drum, and the warm air is circulated through the drum as the clothes are tumbled to remove moisture from laundry articles in the drum. Gas or electric heating elements may be used to heat the air that is circulated through the drum.

Such laundry appliances also typically include a lid or a door to provide selective access to the interior of the laundry appliance, such as to the vessel, e.g., wash tub or drum, therein. The lid or door may include a window or other aperture. In such cases, the window may become smudged or scratched over time. Also, the window may become hot to the touch during certain laundry appliance operations, e.g., in a wash cycle using hot water in a washing machine appliance, a dry cycle using high heat in a dryer appliance, or a steam clean or sanitizing cycle in any laundry appliance. Accordingly, a protective cover or shield may be provided for preventing direct access to the window in the lid or door, such as the shield may be coupled to a frame of the door. Typical shields and other components of the door may be coupled to the frame by snap fit tabs. Such fittings however, may provide a large tolerance and/or may wear out over time, allowing relative movement between the frame and the other component(s) which are snap fit thereto. This relative movement may result in poor perception of the fit and finish of the laundry appliance and may also create noises, e.g., squeaking, which diminish customer satisfaction with the laundry appliance.

Thus, a durable and robust coupling for a door frame and one or more other components in a laundry appliance would be beneficial.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a method of assembling a door assembly for a laundry appliance is provided. The door assembly includes an inner frame, a window in the inner frame, an outer frame outboard of the inner frame and the window and a grille mounted to the outer frame. The door assembly is configured to be rotatably mounted to a cabinet of the laundry appliance. The method includes forming a cap on one of the grille or the outer frame by heat stake welding. As a result, the grille is coupled to the outer frame by the heat stake welded cap.

In accordance with another embodiment of the present disclosure, a laundry appliance is provided. The laundry appliance includes a cabinet. The cabinet defines an opening. The laundry appliance also includes a vessel mounted within the cabinet. The vessel is accessible through the opening. The laundry appliance further includes a door assembly rotatably mounted to the cabinet at the opening. The door assembly is rotatable between a closed position wherein the vessel is enclosed within the cabinet and an open position permitting access to the vessel through the opening. The door assembly includes an inner frame and a window in the inner frame. The door assembly further includes an outer frame outboard of the inner frame and the window. The door assembly also includes a grille mounted to the outer frame. The grille is coupled to the outer frame by a heat stake welded cap formed on one of the grille or the outer frame.

In accordance with yet another embodiment of the present disclosure, a door assembly for a laundry appliance is provided. The laundry appliance includes a cabinet defining an opening and a vessel mounted within the cabinet. The vessel is accessible through the opening. The door assembly is configured to be rotatably mounted to the cabinet at the opening. The door assembly is configured to be rotatable between a closed position wherein the vessel is enclosed within the cabinet and an open position permitting access to the vessel through the opening. The door assembly includes an inner frame and a window in the inner frame. The door assembly also includes an outer frame outboard of the inner frame and the window. A grille is mounted to the outer frame. The grille is coupled to the outer frame by a heat stake welded cap formed on one of the grille or the outer frame.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary washing machine appliance and an exemplary dryer appliance in accordance with one or more exemplary embodiments of the present disclosure.

FIG. 2 provides a transverse cross-sectional view of the exemplary washing machine appliance of FIG. 1.

FIG. 3 provides a perspective view of the exemplary dryer appliance of FIG. 1 with portions of a cabinet of the dryer appliance removed to reveal certain components of the dryer appliance.

FIG. 4 provides a perspective view of a door assembly according to one or more embodiments of the present disclosure which may be incorporated in a laundry appliance such as one of the exemplary laundry appliances illustrated in FIGS. 1 through 3.

FIG. 5 provides an exploded perspective view of the door assembly of FIG. 4.

FIG. 6 provides a front view of a shield, a grille, and an outer frame of the door assembly of FIG. 4.

FIG. 7 provides a back, interior view of the shield, the grille, and the outer frame of FIG. 6.

FIG. 8 provides an enlarged view of a portion of FIG. 7.

FIG. 9 provides a schematic view of a first part of an exemplary heat stake welding process.

FIG. 10 provides a schematic view of a second part of the exemplary heat stake welding process.

FIG. 11 provides a front perspective view of the outer frame of FIG. 6 without a grille.

FIG. 12 provides an enlarged perspective view of a portion of a rear side of the outer frame of FIG. 11.

FIG. 13 provides a front perspective view of a grille which may be assembled to the outer frame of FIG. 11.

FIG. 14 provides a back perspective view of the grille of FIG. 13.

FIG. 15 provides a perspective view of a front side of the outer frame of FIG. 11 and the grille of FIG. 13 assembled together.

FIG. 16 provides an enlarged perspective view of a portion of a rear side of the outer frame and grille of FIG. 15.

FIG. 17 provides a back view of portions of the outer frame and grille assembled together before heat stake welding.

FIG. 18 provides a section view taken along line A-A in FIG. 17.

FIG. 19 provides a back view of portions of the outer frame and grille assembled together after heat stake welding.

FIG. 20 provides a section view taken along line B-B in FIG. 19.

FIG. 21 provides an enlarged view of a portion of FIG. 20.

FIG. 22 provides a flow diagram illustrating an exemplary method of assembling a door assembly for a laundry appliance according to one or more embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

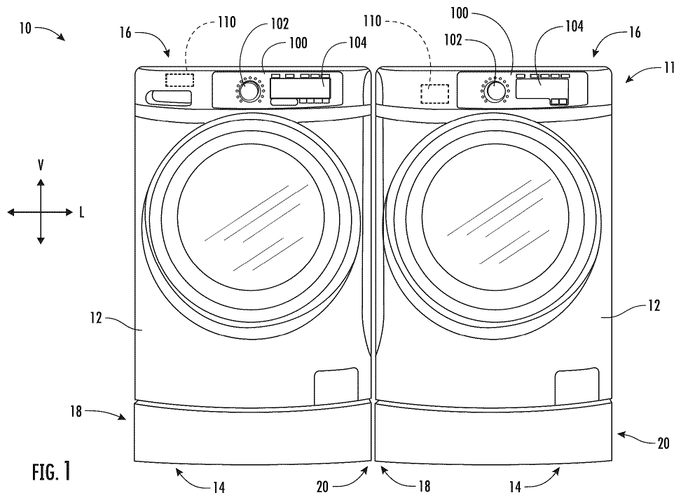

Exemplary laundry appliances are illustrated in FIGS. 1 through 3, e.g., a washing machine appliance and a dryer appliance. In various embodiments of the present subject matter, a laundry appliance may be any suitable laundry appliance, such as a washing machine appliance, a dryer appliance, a combination washer-dryer appliance, etc.

As may be seen generally throughout FIGS. 1 through 3, a user interface panel 100 and a user input device 102 may be positioned on an exterior of the laundry appliance. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Generally, each appliance may include a controller 110 in operative communication with the user input device 102. The user interface panel 100 and the user input device 102 may be in communication with the controller 110 via, for example, one or more signal lines or shared communication busses. Input/output (“I/O”) signals may be routed between controller 110 and various operational components of the appliance. Operation of the appliance can be regulated by the controller 110 that is operatively coupled to the user interface panel 100. A user interface panel 100 may for example provide selections for user manipulation of the operation of an appliance, e.g., via user input device 102 and/or display 104. In response to user manipulation of the user interface panel 100 and/or user input device 102, the controller 110 may operate various components of the appliance. Controller 110 may include a memory and one or more microprocessors, CPUs or the like, such as general or special purpose microprocessors operable to execute programming instructions or micro-control code associated with operation of the appliance. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 110 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 110 may be programmed to operate the appliance by executing instructions stored in memory. For example, the instructions may be software or any set of instructions that when executed by the processing device, cause the processing device to perform operations. Controller 110 can include one or more processor(s) and associated memory device(s) configured to perform a variety of computer-implemented functions and/or instructions (e.g., performing the methods, steps, calculations and the like and storing relevant data as disclosed herein). It should be noted that controllers 110 as disclosed herein are capable of and may be operable to perform any methods and associated method steps as disclosed herein.

In some embodiments, for example, as illustrated in FIG. 1, a laundry appliance may be a washing machine appliance 10 or a dryer appliance 11, and a group of laundry appliances may include multiple washing machine appliances 10 or multiple dryer appliances 11. In embodiments such as illustrated in FIG. 1, the user input device 102 of each appliance 10 and 11 may be positioned on the user interface panel 100. The embodiment illustrated in FIG. 1 also includes a display 104 on the user interface panel 100 of each laundry appliance 10 and 11.

As generally seen throughout FIGS. 1 through 3, in at least some embodiments, each laundry appliance 10 and 11 includes a cabinet 12 which defines a vertical direction V, a lateral direction L, and a transverse direction T that are mutually perpendicular. Each cabinet 12 extends between a top side 16 and a bottom side 14 along the vertical direction V. Each cabinet 12 also extends between a left side 18 and a right side 20, e.g., along the lateral direction L, and between a front side 22 and a rear side 24 along the transverse direction T.

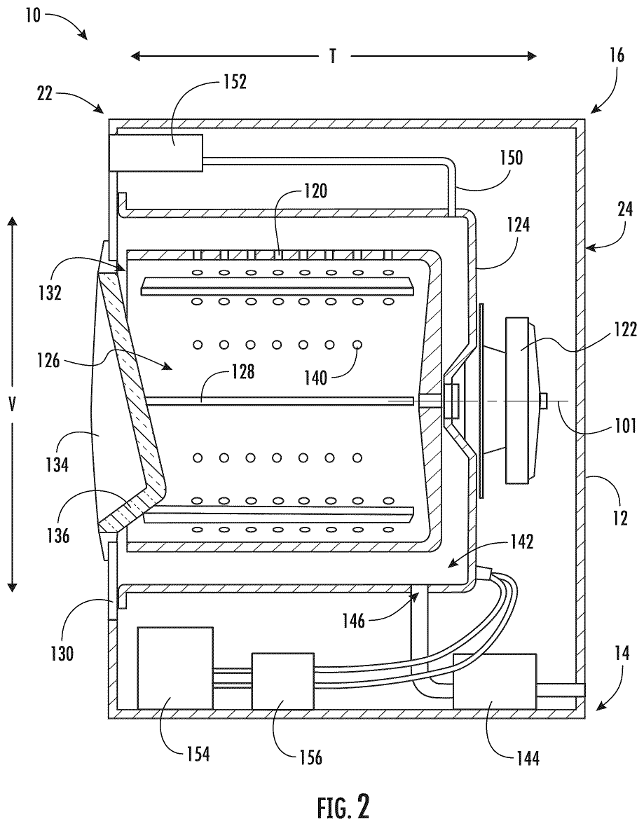

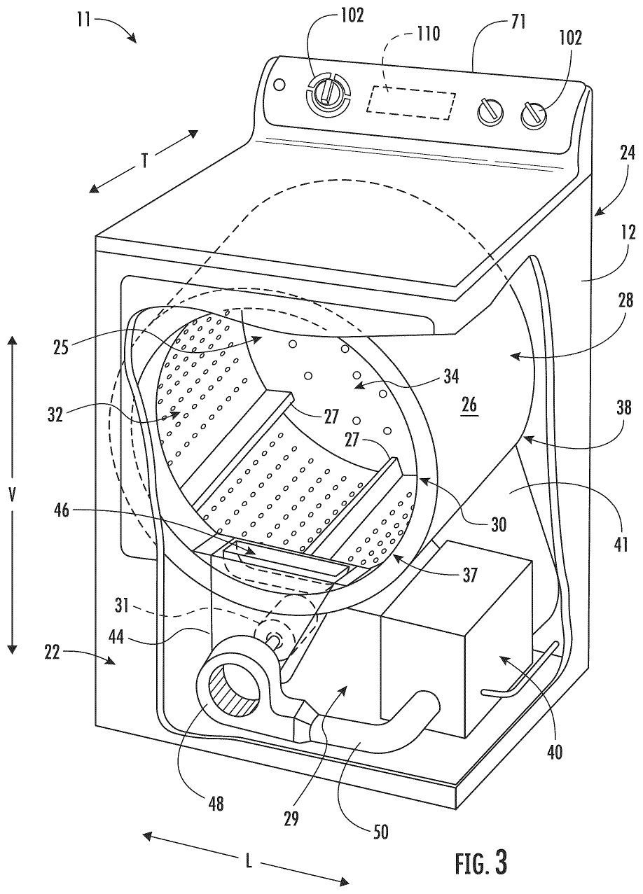

Additional exemplary details of each laundry appliance are illustrated in FIGS. 2 and 3. For example, FIG. 2 provides a cross-sectional view of the exemplary washing machine appliance 10. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the tub 124 such that the wash basket 120 is rotatable about an axis of rotation, which generally coincides with central axis 101 of the tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from basket 120 to sump 142 through plurality of perforations 140. A pump assembly 144 is located beneath tub 124 for gravity assisted flow when draining tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a detergent drawer 152 is slidably mounted within front panel 130. Detergent drawer 152 receives a wash additive (e.g., detergent, fabric softener, bleach, or any other suitable liquid or powder) and directs the fluid additive to wash chamber 124 during operation of washing machine appliance 10. According to the illustrated embodiment, detergent drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user can fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, e.g., during a wash cycle of the washing machine appliance 10, a laundry items are loaded into wash basket 120 through opening 132, and washing operation is initiated through operator manipulation of input selectors 102. Wash tub 124 is filled with water, detergent, and/or other fluid additives, e.g., via spout 150 and/or detergent drawer 152. One or more valves (not shown) can be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, basket 120 is rotated at relatively high speeds. After articles disposed in wash basket 120 are cleaned and/or washed, the user can remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. It should be appreciated that the present subject matter is not limited to any particular style, model, or configuration of washing machine appliance. Other washing machine appliances having different configurations, different appearances, and/or different features may also be utilized with the present subject matter as well, e.g., vertical axis washing machine appliances.

FIG. 3 provides a perspective view of the dryer appliance 11 of FIG. 1, which is an example embodiment of a laundry appliance, with a portion of a cabinet or housing 12 of dryer appliance 11 removed in order to show certain components of dryer appliance 11. Dryer appliance 11 generally defines a vertical direction V, a lateral direction L, and a transverse direction T, each of which is mutually perpendicular, such that an orthogonal coordinate system is defined. While described in the context of a specific embodiment of dryer appliance 11, using the teachings disclosed herein, it will be understood that dryer appliance 11 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” includes but need not be limited to fabrics, textiles, garments, linens, papers, or other items from which the extraction of moisture is desirable. Furthermore, the term “load” or “laundry load” refers to the combination of clothing that may be washed together in a washing machine or dried together in a dryer appliance 11 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 11.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 11 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by supply duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on the cabinet 12 (e.g., on a backsplash 71) and are in operable communication (e.g., electrically coupled or coupled through a wireless network band) with the processing device or controller 110. Controller 110 may also be provided in operable communication with components of the dryer appliance 11 including motor 31, blower 48, or heating system 40. In turn, signals generated in controller 110 direct operation of motor 31, blower 48, or heating system 40 in response to the position of inputs 102. As used herein, “processing device” or “controller” may refer to one or more microprocessors, microcontroller, ASICS, or semiconductor devices and is not restricted necessarily to a single element. The controller 110 may be programmed to operate dryer appliance 11 by executing instructions stored in memory (e.g., non-transitory media). The controller 110 may include, or be associated with, one or more memory elements such as RAM, ROM, or electrically erasable programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller 110.

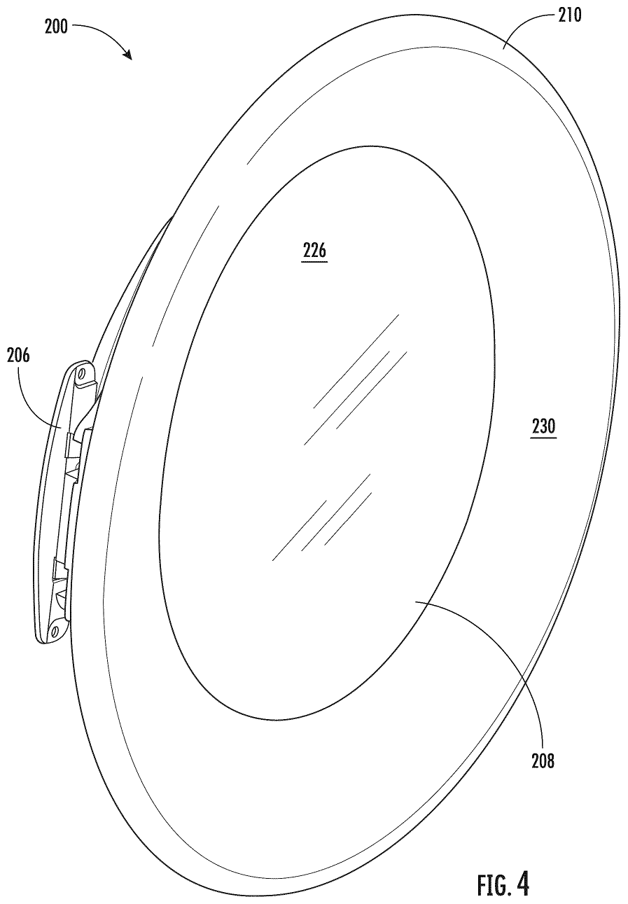

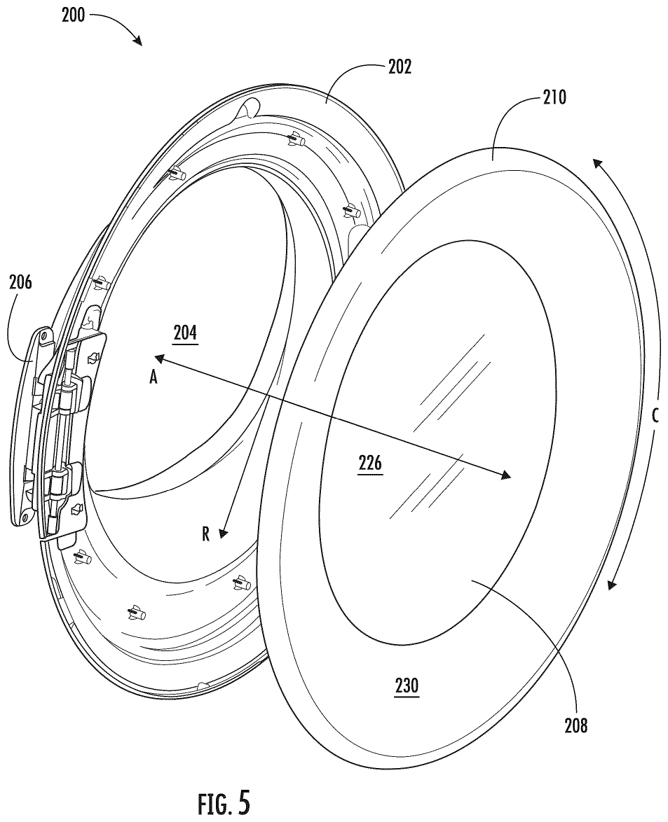

Turning now to FIG. 4, a perspective view of a door assembly 200 of a laundry appliance is provided. FIG. 5 provides a partially exploded view of the door assembly 200, e.g., with a protective cover, e.g., shield 208, and outer frame 210 separated from the remainder of the door assembly 200. Door assembly 200 may be used with any laundry appliance, such as but not limited to, the washing machine appliance 10 or the dryer appliance 11 described above, or numerous other laundry appliances such as a combination washer-dryer appliance, among other possible example laundry appliances. Thus, the door assembly 200 may be an embodiment of door 134 for washing machine appliance 10, or used in place of door 134, or may be a door for a dryer appliance, such as dryer appliance 11, among other possibilities within the scope of the present disclosure.

As may be seen in FIG. 5 in particular, the door assembly 200 may define an axial direction A. For example, the axial direction A may extend through the geometric center of the door assembly 200 and may extend from the interior of the laundry appliance to the exterior of the laundry appliance. For example, the axial direction A may be generally parallel to the transverse direction T in some embodiments, e.g., as in the illustrated embodiments wherein the laundry appliance is a front-load laundry appliance. In other embodiments, the axial direction A may have a different orientation, such as generally parallel to the vertical direction V in top-load embodiments. Also as may be seen, e.g., in FIG. 5, the door assembly 200 may further define a radial direction R perpendicular to the axial direction A and a circumferential direction C that extends around the axial direction A.

As may be seen in FIGS. 4 and 5, door assembly 200 may, in some exemplary embodiments, include an inner frame 202 with a window 204 in the inner frame 202. The window 204 and inner frame 202 may define an inner portion of the door assembly 200, e.g., may be positioned closest to the interior of the laundry appliance, such as when the door assembly 200 is in the closed position, relative to the other portions of the door assembly 200, such as a shield 208 and outer frame 210, e.g., the shield 208 may be positioned outboard, e.g., along the axial direction A, such as closer to the exterior of the laundry appliance and facing away from the interior of the laundry appliance, of the window 204, whereby the shield 208 may protect the window 204, e.g., from scratches or smudges, and may prevent a user from touching the window 204, e.g., when the window 204 becomes hot, such as in embodiments where the laundry appliance is a dryer appliance and/or the laundry appliance includes a steam clean or other high-temperature operation (in various embodiments, the steam clean may be used for cleaning and/or sterilizing the laundry appliance itself in any laundry appliance, or may be used for treating, e.g., cleaning, laundry articles within the laundry appliance, e.g., in embodiments where the laundry appliance is a washing machine appliance or combination washer-dryer appliance). The door assembly 200 may be mountable to the cabinet of the laundry appliance, such as rotatably mountable to the cabinet, by a hinge 206.

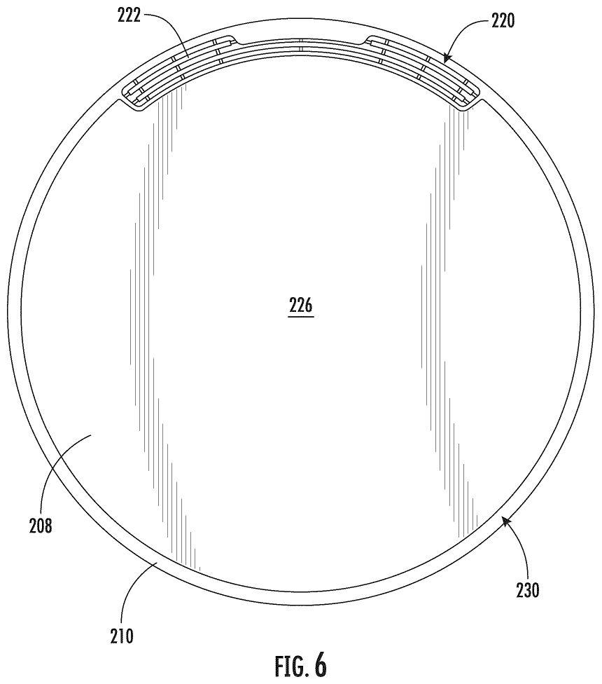

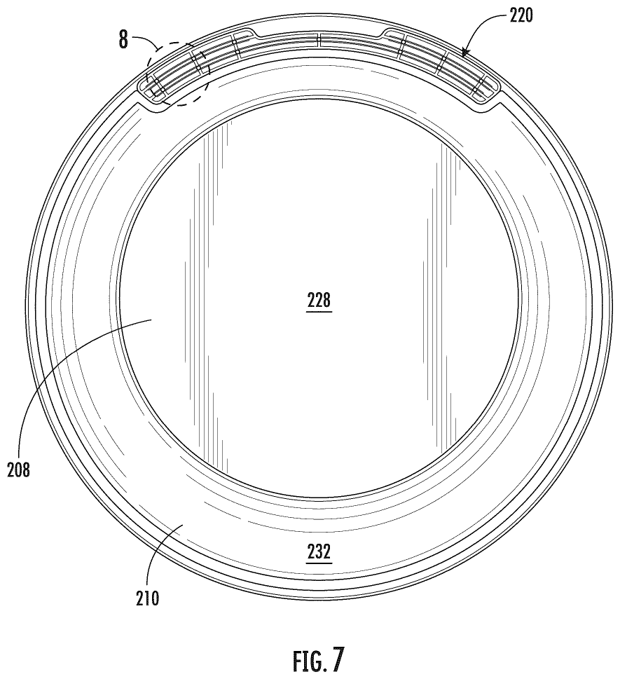

As may be seen, e.g., in FIGS. 5, 6, and 7, the shield 208 comprises a front or outer surface 226 and an opposing back or inner surface 228 and the outer frame 210 comprises a front or outer surface 230 and an opposing back or inner surface 232. It should be understood that the door assembly 200 may also be used in a lid, e.g., a door in a top surface of a laundry appliance, where the “front” in such embodiments may also be referred to as “top” or “upper” and “back” in such embodiments may also be referred to as “bottom” or “lower,” such that the description herein of a door assembly for a front-load laundry appliance is by way of example only and the possible orientations of the door assembly are not intended to be limited. Further, “inner” and “outer” are used herein with respect to an interior of the laundry appliance, such as a center of the laundry appliance, e.g., such that “inner” refers to closer to the interior and/or the center thereof while “outer” refers to a position that is away from the interior and/or the center thereof. In particular, the inner surface 228 of the shield 208 and the inner surface 232 of the outer frame 210 may be seen in FIG. 7, while the outer surface 226 of the shield 208 and the outer surface 230 of the outer frame 210 may be seen in FIGS. 5 and 6.

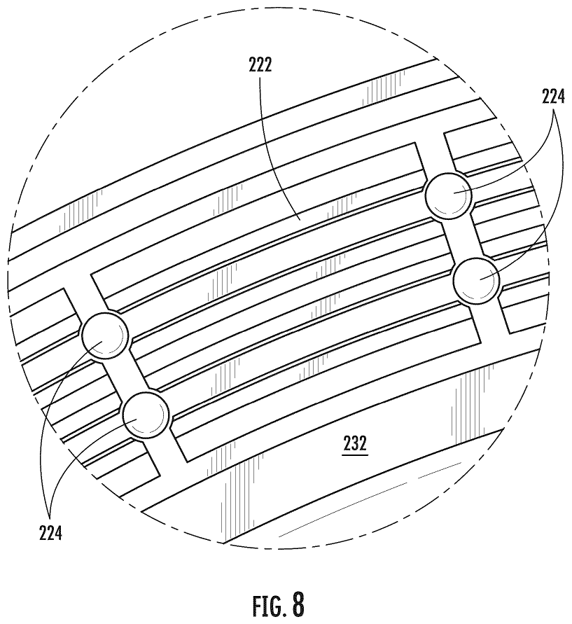

In some embodiments, e.g., as illustrated in FIG. 6, a vent 220 may be formed in the outer frame 210, and a grille 222 may be provided in the vent 220. As will be described further below, the grille 222 may be heat staked to the outer frame 210, such as in the vent 220 of the outer frame 210. As may be seen, e.g., in FIGS. 8, 20, and 21, the grille 222 may include posts or bosses 234 which extend through the outer frame 210, with a cap 224 formed on a distal end of each boss 234, e.g., the cap 224 of each boss 234 may abut the back surface 232 of the outer frame 210. For example, the caps 224 on the bosses 234 may be formed by heat stake welding to thereby join the grille 222 and the outer frame 210 together.

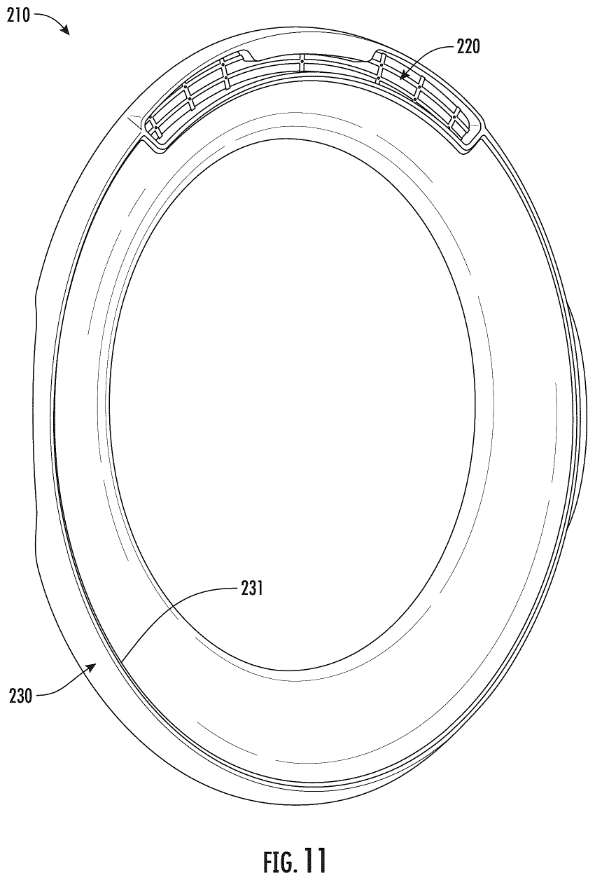

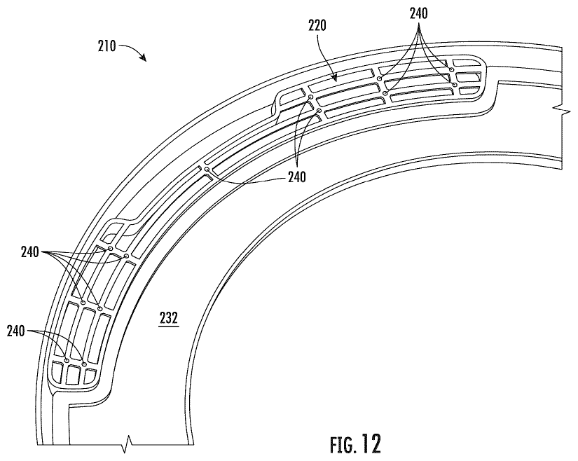

The outer frame 210 is illustrated in isolation in FIGS. 11 and 12, e.g., without other components of the door assembly, such as the grille 222 coupled to the vent 220, such as in a pre-assembly condition prior to coupling the grille 222 to the outer frame 210, e.g., to the vent 220 of the outer frame 210. As may be seen, e.g., in FIGS. 11 and 12, the vent 220 may comprise a plurality of elongate members, such as radially oriented elongate members and circumferentially oriented elongate members, with vent apertures defined between the elongate members. A plurality of through holes or passages 240 may be formed in the outer frame 210, such as in the vent 220, for receiving the bosses 234 of the grille 222. For example, the passages 240 may be formed in one or more of the elongate members of the vent 220, such as at one or more intersections of a radial elongate member with a circumferential elongate member, e.g., at each intersection as illustrated in FIGS. 11 and 12. Also as may be seen in FIG. 11 (e.g., where the shield 208 is not present in FIG. 11), a ledge 231 may be defined in the outer frame 210, e.g., at an inner boundary of the front surface 230, and the shield 208 may be received in the outer frame 210 at the ledge 231, e.g., an outer perimeter of the shield 208 may be received within and resting against the ledge 231 of the outer frame 210 when the shield 208 is assembled to the outer frame 210.

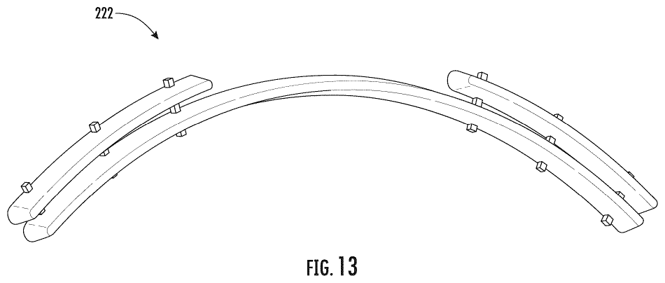

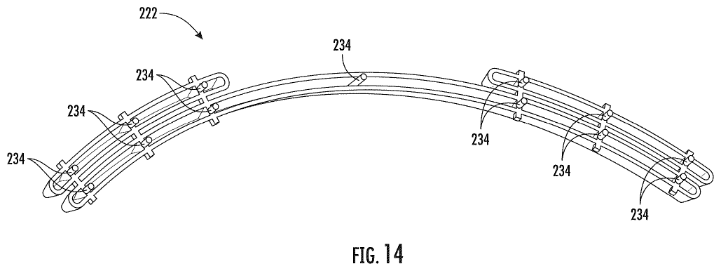

FIGS. 13 and 14 provide perspective views of the grille 222 in isolation, e.g., apart from other components of the door assembly such as the outer frame 210, such as in a pre-installation condition. In particular, FIG. 13 provides a front perspective view and FIG. 14 provides a rear perspective view. As may be seen in FIG. 14, in the pre-installation or pre-assembly condition of the grille 222, the bosses 234 may be cylindrical. As may be seen, e.g., in FIGS. 12 and 14, the grille 222 may include circumferential elements and radial elements with bosses 234 at each intersection of such elements, e.g., whereby the number and arrangement of the bosses 234 corresponds to the passages 240 (FIG. 12) in the outer frame 210.

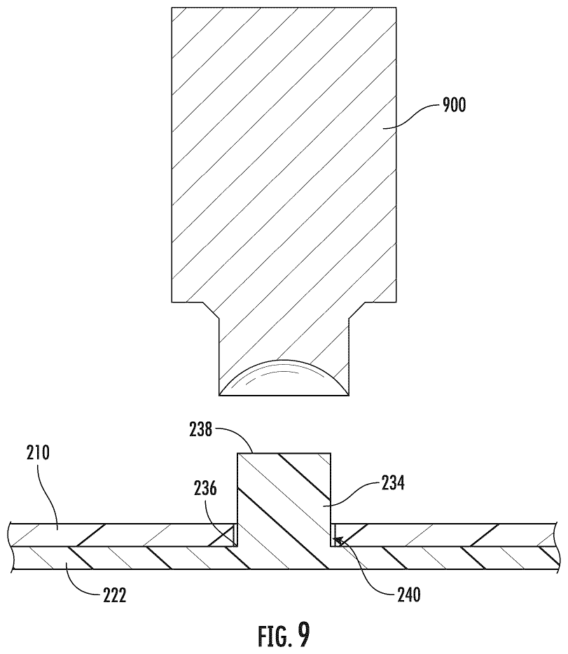

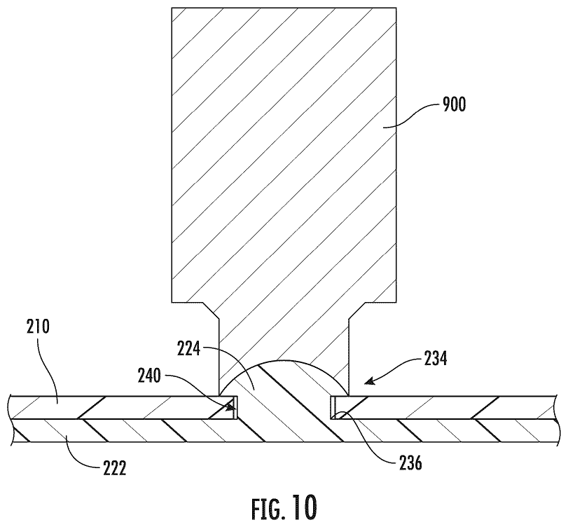

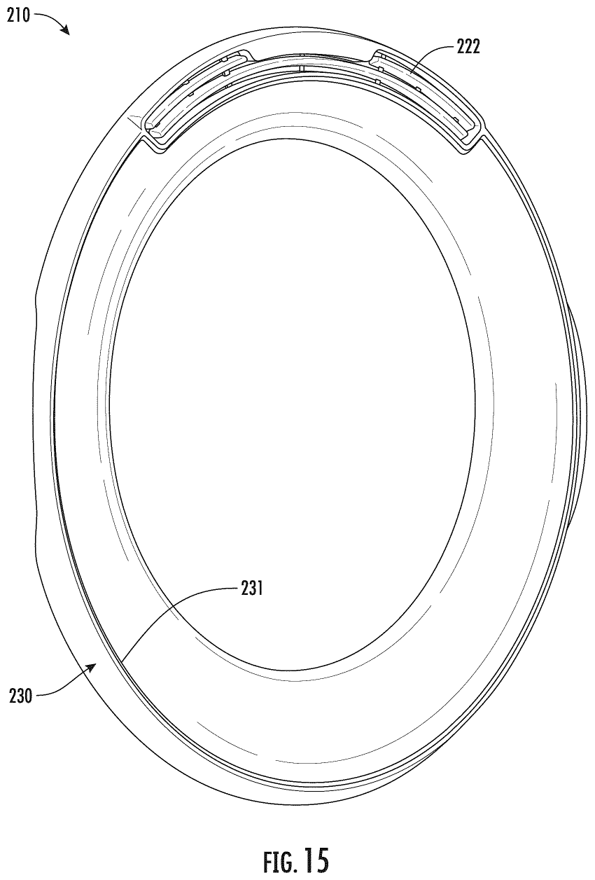

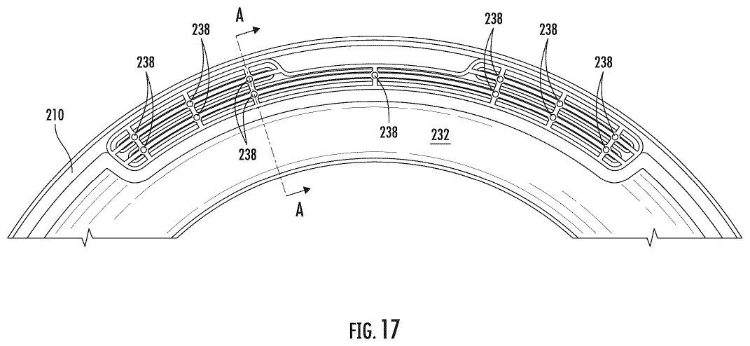

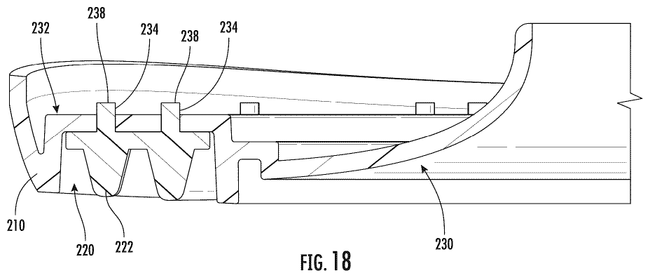

FIGS. 15, 16, 17, and 18 illustrate the outer frame 210 with the grille 222 received therein, e.g., in the vent 220, but prior to complete assembly, such as prior to heat staking. As noted above, the bosses 234 may be cylindrical in their initial form, such as prior to heat staking. For example, as best seen in FIG. 18, each boss 234 may begin at and extend from a proximal end 236 (see, e.g., FIGS. 9 and 10) which adjoins a main body of the grille 222 and may extend to and end at a distal end 238, where the boss 234 is entirely cylindrical from the proximal end 236 to the distal end 238 prior to assembly, and in particular prior to heat staking.

An exemplary heat staking or heat stake welding process is schematically illustrated in FIGS. 9 and 10. The heat staking process illustrated in FIGS. 9 and 10 may be applied to various different components, such as the outer frame 210 and grille 222. In additional embodiments, the order of the components may be rearranged, such as the boss 234 may be provided on the outer frame 210 and may be passed through a passage 240 in the grille 222. As shown in FIGS. 9 and 10, the heat staking process may utilize a forming tool 900. For example, the forming tool 900 may be heated, e.g., to a temperature sufficient to soften the material of the boss 234 (e.g., on the grille 222 in the illustrated exemplary embodiment). The material of the boss 234, as well as the grille 222 overall, and the outer frame 210 as well, may be any suitable material for such heat staking, such as a plastic material, e.g., a thermoplastic material. The boss 234 may also or instead be heated by a separate heating source to soften the material thereof such that the boss becomes malleable for forming into a fastening feature. For example, the fastening feature may be or may include a cap 224 (FIG. 10) on the distal end 238 of the boss 234. The forming tool 900 may be pressed down onto the boss 234, such that the combination of heat and pressure forms the boss 234 as desired, e.g., to form the cap 224 thereon.

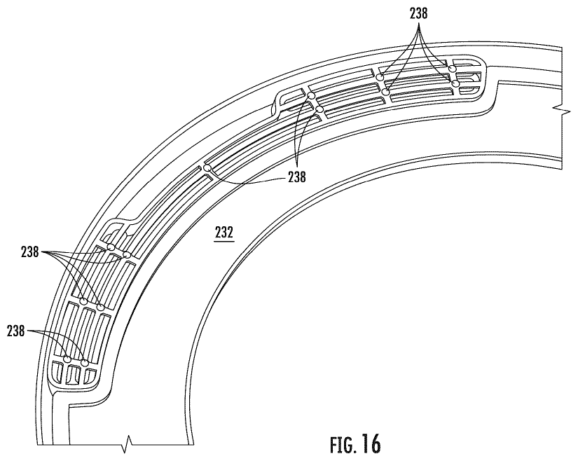

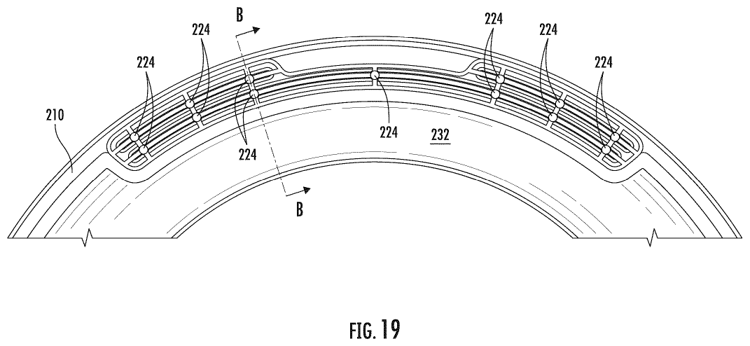

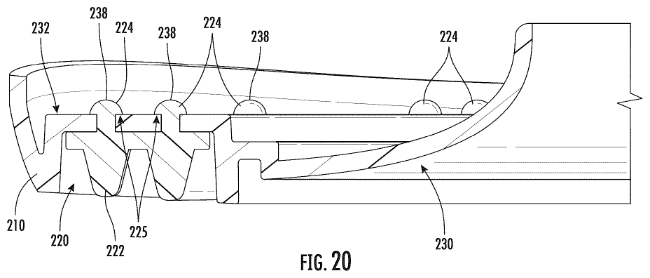

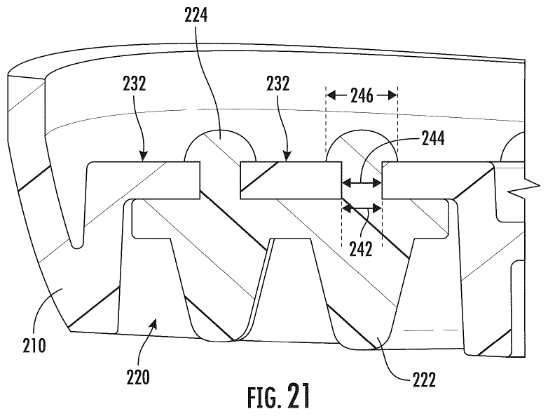

After the heat staking process has been carried out, the grille 222 may be coupled to the outer frame 210, e.g., by the heat stake welded cap 224, as may be seen, for example, in FIGS. 19, 20, and 21. As may be seen in FIG. 19, a cap 224 may be formed on each boss 234 (see, e.g., FIGS. 16, 17, and 18) and at each passage 240 (see, e.g., FIG. 12) of the outer frame 210. As may be seen, e.g., in FIGS. 20 and 21, the cap 224 may be formed as a portion of a sphere, e.g., a hemisphere or other spherical cap or spherical dome. For example, the cap 224 may form a partial sphere at the distal end 238 of the boss 234, e.g., the distal end 238 of the boss 234 may be defined at the apex of the spherical dome formed by the cap 224 after the heat stake welding process. It should be recognized, however, that the cap 224 is not necessarily a spherical cap. In additional embodiments, the cap 224 may be provided in various shapes which generally define a deformation by which the grille 222 and outer frame 210 may be coupled and retained together. For one example, the cap 224 may be a rosette style heat stake weld. As additional examples, the cap 224 may have a polygonal cross-sectional shape, such as hexagonal, octagonal, etc. In further exemplary embodiments, the cap 224 may be provided as a rectangular prism, e.g., cuboid or cube, a cone or a pyramid (or a segment thereof, e.g., a frustum of a cone or a frustum of a pyramid), and so forth. For example, in embodiments where the cap 224 is pyramidal (e.g., a pyramid or frustum of a pyramid), the pyramidal cap 224 may have a rectangular base or a triangular base. As yet another example, the cap 224 may be at least partially hollow, e.g., wherein the material of the boss 234 is flared out during heat stake welding, which may advantageously provide even holding strength fully around the outer perimeter of the cap 224. In further exemplary embodiments, the cap 224 may be knurled, may be a high-profile stake (such as the exemplary partial sphere in the illustrated embodiments), a low-profile stake, or a flush stake.

In such embodiments, a proximal portion of the boss 234 (e.g., a portion of the boss 234 including and beginning at the proximal end 236) may remain cylindrical after forming the cap 224 on the distal end 238 of the boss 234. For example, such proximal portion may extend through and be retained in the passage 240 of the outer frame 210. Also as may be seen in FIGS. 20 and 21, the proximal portion of the boss 234 may define an outer diameter 242, the passage 240 may define an inner diameter 244, and the cap may define a maximum diameter 246 (or other major dimension of the cap, e.g., in embodiments where the cap is provided with a polygonal cross-sectional shape, such as the diagonal of a square or rectangle, or a diagonal passing through the center of a hexagonal cross-section of the cap, etc., or the major axis of an elliptical cross-section of the cap in additional embodiments) at a shoulder 225 of the boss 234. In such embodiments, the shoulder 225 may abut the inner surface 232 of the outer frame 210, such as at and around the distal end of the respective passage 240. The maximum diameter 246 of the cap 224 may be greater than the inner diameter 244 of the passage 240, e.g., such that the grille 222 and the outer frame 210 are held together by these dimensions preventing or restricting the cap 224 from passing back through the passage 240.

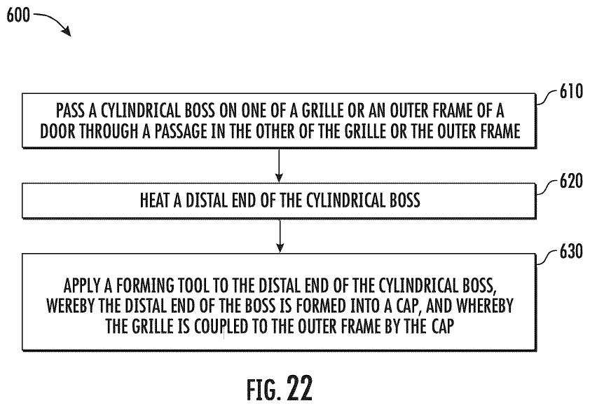

Turning now to FIG. 22, embodiments of the present disclosure also include methods of assembling a door assembly for a laundry appliance, such as the illustrated exemplary door assembly described above and illustrated in FIGS. 1-21, or other door assemblies in additional embodiments. Thus, for example, the door assembly may include an inner frame, a window in the inner frame, an outer frame outboard of the inner frame and the window and a grille mounted to the outer frame. In such embodiments, the door assembly may be configured to be rotatably mounted to a cabinet of the laundry appliance. As shown in FIG. 22, an exemplary method 600 of assembling the door assembly may include (610) passing a cylindrical boss on one of the grille or the outer frame through a passage in the other of the grille or the outer frame. After passing the cylindrical boss on the one of the grille or the outer frame through the passage in the other of the grille or the outer frame, method 600 may proceed to (620) heating a distal end of the cylindrical boss. Method 600 may further include (630) applying a forming tool to the distal end of the cylindrical boss, whereby the distal end of the cylindrical boss is formed into the cap. The cap may be formed at the distal end of the boss, and may include a partial sphere (e.g., spherical cap or spherical dome), or any other suitable shape, such as any of the example shapes described above. As a result of forming the cap on the distal end of the boss, the grille may be coupled to the outer frame by the heat stake welded cap.

In some embodiments, processes (620) and (630) may overlap in time, e.g., may be performed simultaneously. For example, the forming tool may be heated, such that applying the forming tool to the distal end of the boss also heats the distal end of the boss.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of assembling a door assembly for a laundry appliance, the door assembly comprising an inner frame, a window in the inner frame, an outer frame outboard of the inner frame and the window and a grille mounted to the outer frame, the door assembly configured to be rotatably mounted to a cabinet of the laundry appliance, the method comprising:
forming a cap on one of the grille or the outer frame by heat stake welding, whereby the grille is coupled to the outer frame by the heat stake welded cap.

2. The method of claim 1, further comprising passing a cylindrical boss on the one of the grille or the outer frame through a passage in the other of the grille or the outer frame prior to forming the cap on the one of the grille or the outer frame by heat stake welding.

3. The method of claim 2, wherein forming the cap on the one of the grille or the outer frame comprises heating a distal end of the cylindrical boss, and applying a forming tool to the distal end of the cylindrical boss, whereby the distal end of the cylindrical boss is formed into the cap.

4. The method of claim 3, wherein heating the distal end of the cylindrical boss comprises heating the forming tool, whereby applying the forming tool to the distal end of the boss also heats the distal end of the boss.

5. The method of claim 3, wherein a proximal portion of the boss remains cylindrical after forming the cap on the distal end of the boss.

6. The method of claim 5, wherein the proximal portion of the boss defines an outer diameter, the passage defines an inner diameter, and the cap defines a major dimension at a shoulder of the boss.

7. The method of claim 6, wherein the shoulder of the boss abuts a distal end of the passage.

8. The method of claim 6, wherein the major dimension of the cap is greater than the inner diameter of the passage.

9. The method of claim 1, wherein the one of the grille or the outer frame comprises a plastic material.

10. The method of claim 9, wherein the other of the grille or the outer frame comprises a plastic material.

11. A laundry appliance, comprising:
a cabinet defining an opening;
a vessel mounted within the cabinet, the vessel accessible through the opening; and
a door assembly rotatably mounted to the cabinet at the opening, the door assembly rotatable between a closed position wherein the vessel is enclosed within the cabinet and an open position permitting access to the vessel through the opening, the door assembly comprising:
an inner frame;
a window in the inner frame;
an outer frame outboard of the inner frame and the window; and
a grille mounted to the outer frame, wherein the grille is coupled to the outer frame by a heat stake welded cap formed on one of the grille or the outer frame.

12. The laundry appliance of claim 11, wherein the cap is formed on a distal end of a boss of the one of the grille and outer frame, the boss comprising a cylindrical proximal portion, the proximal portion of the boss extending through a passage in the other of the grille or the outer frame.

13. The laundry appliance of claim 12, wherein the proximal portion of the boss defines an outer diameter, the passage defines an inner diameter, and the cap defines a major dimension at a shoulder of the boss.

14. The laundry appliance of claim 13, wherein the shoulder of the boss abuts a distal end of the passage.

15. The laundry appliance of claim 13, wherein the major dimension of the cap is greater than the inner diameter of the passage.

16. A door assembly for a laundry appliance, the laundry appliance comprising a cabinet defining an opening and a vessel mounted within the cabinet, the vessel accessible through the opening, the door assembly configured to be rotatably mounted to the cabinet at the opening, the door assembly configured to be rotatable between a closed position wherein the vessel is enclosed within the cabinet and an open position permitting access to the vessel through the opening, the door assembly comprising:
an inner frame;
a window in the inner frame;
an outer frame outboard of the inner frame and the window; and
a grille mounted to the outer frame, wherein the grille is coupled to the outer frame by a heat stake welded cap formed on one of the grille or the outer frame.

17. The door assembly of claim 16, wherein the cap is formed on a distal end of a boss of the one of the grille and outer frame, the boss comprising a cylindrical proximal portion, the proximal portion of the boss extending through a passage in the other of the grille or the outer frame, and the cap at the distal end of the boss.

18. The door assembly of claim 17, wherein the proximal portion of the boss defines an outer diameter, the passage defines an inner diameter, and the cap defines a major dimension at a shoulder of the boss.

19. The door assembly of claim 18, wherein the shoulder of the boss abuts a distal end of the passage.

20. The door assembly of claim 18, wherein the major dimension of the cap is greater than the inner diameter of the passage.
